(19) United States
(12) Patent Application Publication
(10) Pub. No.: US 2015/0113877 A1
(43) Pub. Date: Apr. 30, 2015

(54) Access Point Security Unit

(71) Applicant: QINETIQ LIMITED, Hampshire (GB)

(72) Inventors: Kenneth Andrew Pink, Fareham (GB); Philip John Dandy, Farnborough (GB); David Banks-Fear, Christchurch (GB)

(73) Assignee: QINETIQ LIMITED, Hampshire (GB)

(21) Appl. No.: 14/399,475

(22) PCT Filed: May 8, 2013
(86) PCT No.: PCT/GB2013/000202

§ 371 Date: Nov. 6, 2014

Related U.S. Application Data
(60) Provisional application No. 61/654,172, filed on Jun. 1, 2012.

(30) Foreign Application Priority Data
May 9, 2012 (GB) 1208078.4
Mar. 14, 2013 (GB) 1304643.8

(51) Int. Cl. E06B 9/02; E06B 11/00; E06B 9/68; E06B 9/00

(52) U.S. Cl. CPC E06B 9/02; E06B 9/00; E06B 11/00; E06B 9/68; E06B 2009/002
USPC 49/56

(57) ABSTRACT

Some embodiments relate to an access point security unit which, when deployed, provides a hindrance for passing through an access point. Such a unit includes a deployment apparatus and a plurality of lengths of barbed strip material which can be moved between a stowed position, in which the access point is not obstructed by barbed strip material and a deployed position, in which the plurality of lengths of barbed strip material lie across the access point. In the deployed position, the barbed strip material is, in some embodiments, fully enclosed unless the access point is breached.

The present invention relates to apparatus and associated methods for providing security to points of access, such as doorways, windows, entry portals and/or covers to cabinets, cupboards or other containers, vents and vent ducts, passageways and the like.

There are many situations in which there is a need to deny and/or secure access to all or a region of a building, an aircraft, a train, or to the interior of containers, etc. Considering the example of securing a building, it is known to provide reinforced doors and windows, both to discourage attempts to gain access and to resist any such attempt which is made. It is also known to use barbed wire or similar technologies in order to form a perimeter fence around an area or to form a barrier at a point of entry to a building.

However, conventional barbed wire is slow and difficult to deploy and can be logistically difficult to carry by dismounted troops or other users. Furthermore, it can be too aggressive for a given situation and can cause significant injury. This may be highly undesirable, for example, when the barbed wire may be encountered by a civilian population. The use of barbed wire or similar technologies can also be visually unappealing.

According to a first aspect of the invention there is provided access point security unit arranged, when deployed, to provide a hindrance to passage through an access point, the unit comprising a deployment apparatus and a plurality of lengths of barbed strip material, wherein the deployment apparatus is arranged to move the plurality of lengths of barbed strip material between a stowed position, in which the access point is not obstructed by barbed strip material, and a deployed position in which the plurality of lengths of barbed strip material lie across the access point.

In preferred embodiments, the barbed strip material is fully enclosed on all sides unless the access point is breached. In some examples, the barbed strip material is fully enclosed on all sides unless the point of access is breached when the unit is in the deployed position. This is advantageous as it ensures barbs are only exposed when necessary and will not generally present an injury risk.

In one embodiment, the lengths of barbed strip material are held in a frame, and the frame may be moved from the stowed position to the deployed position. This provides for ease of movement of the barbed material.

The barbed material may be arranged, in at least one of the stowed and deployed position, to lie between sheets of sheet material, one or more of which may be translucent. In a particularly preferred embodiment, when in the deployed position, the lengths of barbed strip material are interposed between sheets of glass or other translucent materials. Therefore, the unit can still provide the function of a glass door or window opening, allowing light to pass therethrough. It also allows the strips to be seen when the unit is deployed, presenting a visible deterrent, discouraging attempts to breach the access point.

The unit may be arranged to form at least part of a ‘double glazed’ window. In such embodiments, the barbed strip material may be mounted on a frame, which can be moved into position between the panes of a double glazing arrangement. This presents a convenient way of increasing the security of a glazed access point. In other embodiments, the frame may itself comprise one or more panes of glass/other similar sheet translucent material. Therefore, in the deployed position, the frame could also act to glaze, or provide secondary glazing, to an access point.

In the stowed position, the barbed strip material may be stored in a cavity formed within a structure surrounding the access point. For example, this may conveniently simply make use of the existing cavity in a cavity wall, or other hollow space in a building, container or the like, or may be a purpose-built cavity. Storing the barbed tape in such a cavity may be advantageous as it reduces the risk of the barbs being exposed, and also removes the barbs from view when in a stowed position. In other examples, the stowage cavity could be in a ceiling or floor or the like.

In either or both of the stowed/deployed positions, the barbed strips may be arranged substantially vertically, substantially horizontally, diagonally, or in a mixture of these and other orientations.

In some embodiments, the strip material is coiled on one or more spools when in the stowed position, and deployed by drawing the strip material from the spool(s).

The deployment apparatus arranged to assist in moving the barbed strip material between the stowed and deployed positions may comprise any suitable apparatus, e.g. rams, pulleys, hinges or the like. These may be, for example, manually powered, spring loaded, pneumatically driven and/or, alternatively or additionally, the access point security unit may comprise a motor associated with an energy source arranged to drive the deployment apparatus. The deployment apparatus is preferably arranged to quickly deploy the barbed strip material, for example within a few seconds.

In a preferred embodiment, the strip material is comprises ‘micro barbed tape’, which term is used herein to refer to barbs which are smaller, and therefore less injurious, that current barbed wires or tapes. In particular, a micro barbed tape according to the invention may be produced from a stock tape of around 5-20 mm in width. Further, such ‘micro barbed tape’ is preferably relatively thin, for example between 100-1000 microns, and more preferably 100-600 microns. The length of each barb is preferably between 2 mm to 30 mm. Such tape is discussed in greater detail in our copending applications, which bear reference numbers P7877, P7878 and P7879, which are incorporated herein to the fullest extent allowable.

Such tape is relatively light and, in particular if coiled, relatively large amounts can be held in a relatively small volume. The fact that the barbs are not excessively injurious means that the tape is suitable for use in a greater variety of circumstance, and safeguards the wellbeing of an individual who may encounter the tape.

In one embodiment, the tape is formed from a planar strip of flexible material, which may be relatively thin and comprises a plurality of barbs disposed therealong, said barbs being sufficiently resilient so as to impede, by entanglement with or otherwise, the passage of an object therepast.

Such tape provides a low-risk and novel approach to the concept of barbed wire, which in this invention is scaled and packaged to form a non-lethal counter personnel capability for access point control.

The barbed tape may therefore be designed to be non-lethal and inflict only light injuries but presents an entanglement feature that inhibits free passage of a person, in whole or in part, through a doorway, along a passage or transiting through a portal. (e.g. a window, access to the interior of a display case, through vent ducts etc).

However, in other embodiments, other barbed strip material, including barbed wire and known variants thereof, whether formed of metals or other materials, may be used.

Embodiments of the present invention will now be described, by way of example only, with reference to the accompanying drawings, in which;

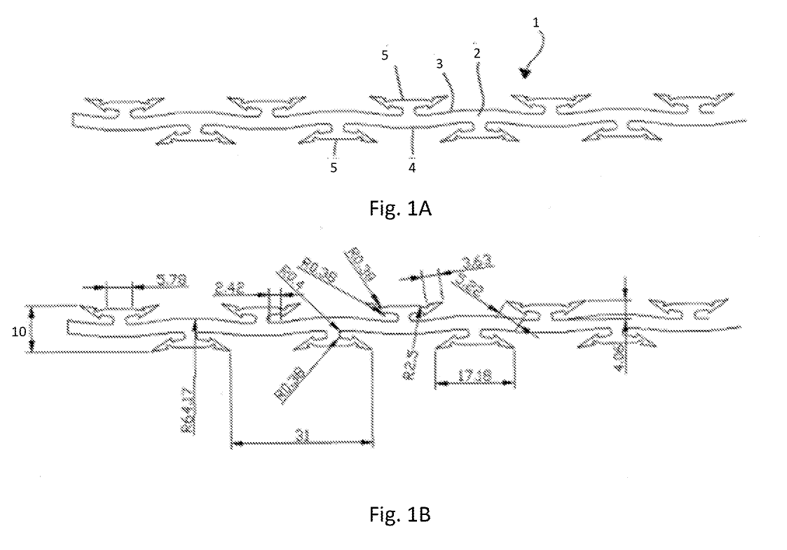

FIG. 1 is a top plan view of a strip of barbed tape according to an embodiment of the present invention;

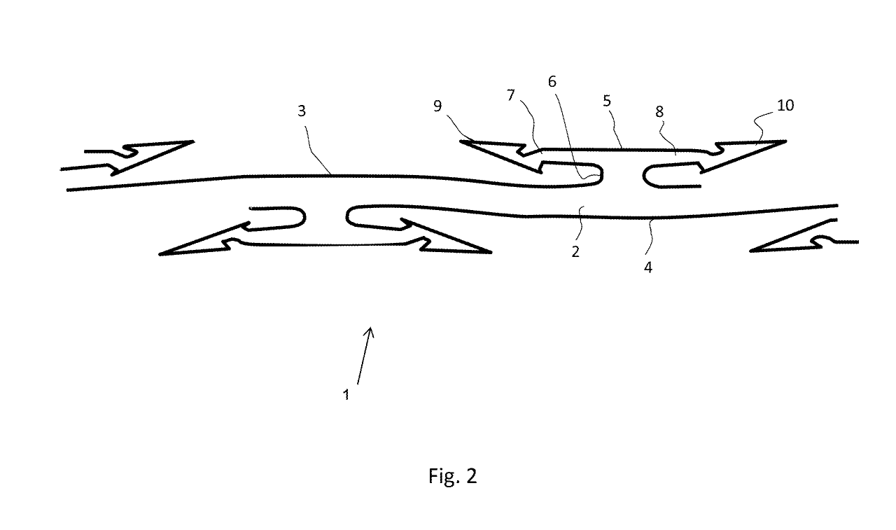

FIG. 2 is an enlarged view of a section of the barbed tape shown in FIG. 1;

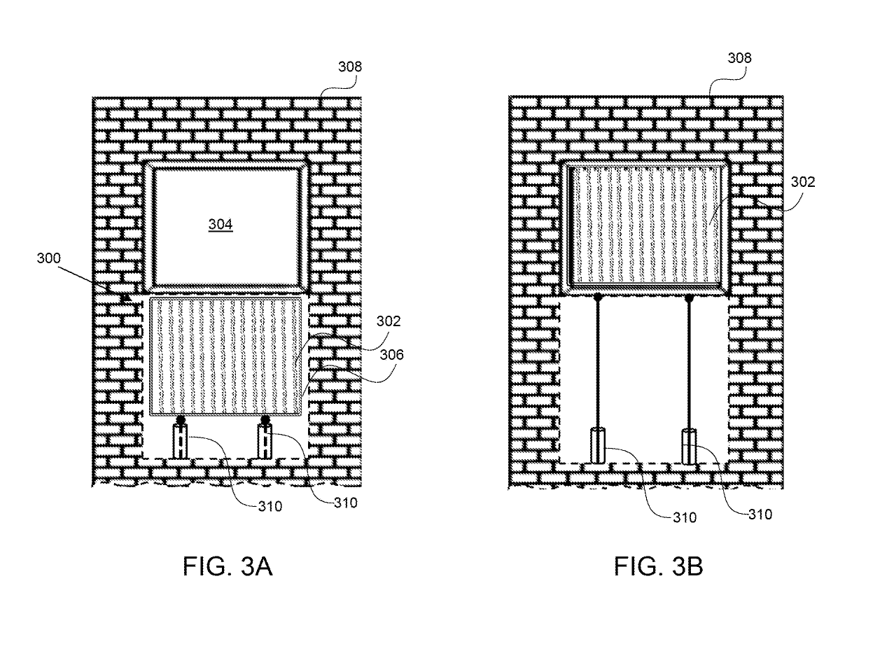

FIGS. 3A and 3B show a first embodiment of the invention in situ in a stowed and a deployed state respectively

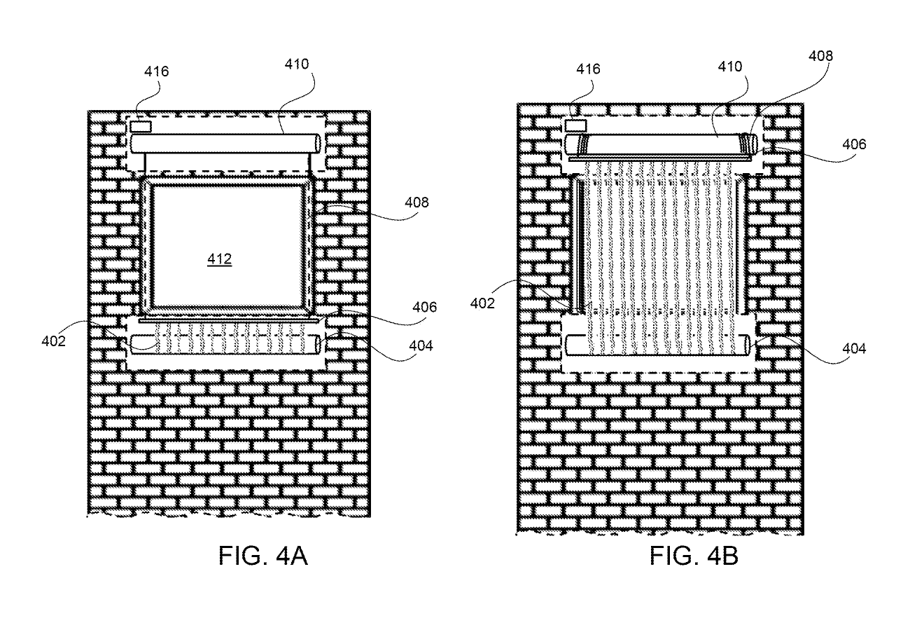

FIGS. 4A and 4B show a second embodiment of the invention in situ in a stowed and a deployed state respectively; and

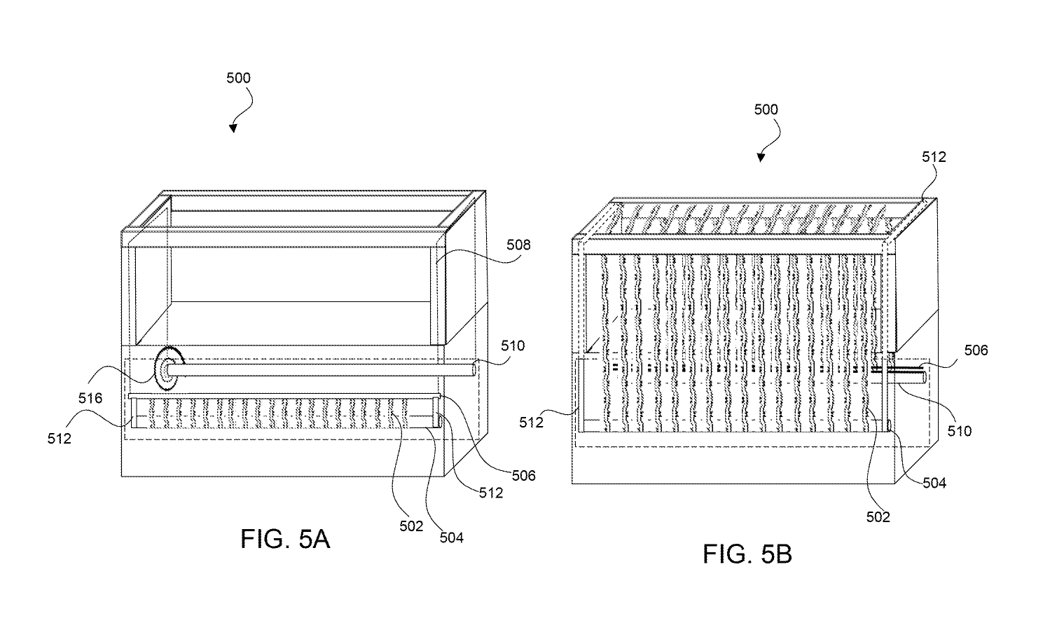

FIGS. 5A and 5B show a third embodiment of the invention in situ in a stowed and a deployed state respectively.

Referring to FIGS. 1 and 2, a barbed tape 1 is formed from a substantially planar strip of flexible material. In the presently described embodiment, the barbed tape 1 is punched from a strip of stainless steel having a nominal width of 10 mm and a nominal thickness of 250 to 500 microns. In alternative embodiments of the present invention, the barbed tape 1 may be formed from, for example, mild steel or other metals including non-ferrous metals, polymers or plastics materials.

The strip of barbed tape 1 is formed with a continuous central portion 2, which has first and second parallel edges 3, 4. A plurality of barbs 5 are disposed at regularly spaced locations along each of the first and second edges 3, 4. Each of the barbs 5 is formed as a ‘double barb’ having a T-shape and comprising a connecting portion 6 which projects laterally from the respective edge 3, 4 of the central portion 2 of the strip. A pair of arms 7, 8 are disposed at the distal end of the connecting portion 6, furthest from the central portion 2 of the strip. The arms 7, 8 extend in respective opposite directions from the distal end of the connecting portion 6 parallel to the lengthwise direction of the adjacent central portion 2 of the strip. The arms 7, 8 terminate with a respective pair of spikes 9, 10. Each of the spikes 9, 10 is substantially triangular in shape having a pointed tip which is defined by an acute angle between the two major sides thereof. The connecting portion 6 of each barb 5 acts to space the pairs of spikes 9, 10 from the central portion 2 of the strip. Furthermore, each spike 9, 10 is shaped such that it tapers away from the central portion 2 of the strip.

Exemplary dimensions of the above-described features of the barbed tape 1 are shown in millimetres in FIG. 1B.

The use of a relatively thin material is advantageous as it means that the resulting barbed tape 1 is lightweight and can be easily stowed. Furthermore, the flexibility of the barbed tape 1 ensures that it can deform around an object which it comes into contact with so as to ensnare the object. The barbed tape 1 is also conveniently designed (such as shown in FIG. 2) so as to limit the injurious effects of the tape as the spikes 9, 10 are too short to penetrate deeply into skin. Preferably, the barbed tape 1 is no more injurious than natural brambles.

Trials conducted by the Applicant have found that barbed tape 1 according to the presently described embodiment, which has a thickness of, say, 250 or 500 microns, has a tensile strength and profile which means that it cannot readily be pulled apart by hand. The distribution of the barbs 5 along each edge 3, 4 of the barbed tape 1 is such that they are closer together than the span of a typical human hand. Accordingly, a person cannot hold onto the tape 1 at any point in an attempt to tear it apart without being impinged on at least one set of spikes 9, 10.

The ‘double barbed’ design of the presently described embodiment, while not essential, advantageously ensures that that clothing, etc. caught thereon is thoroughly ensnared. The location and spacing of the barbs 5 is set so as to take advantage of the reaction of a body to being impinged by a spike 9, 10 (either directly or through clothing), which is to withdraw from the point of pain. The rapid withdraw reaction has the effect of impaling the offending part of the body onto the adjacent spike. Thus, the “pull away” response from the first contact with the barbed tape 1 is likely to cause greater contact with an adjacent spike 9, 10. The only way to stop this sequence is to halt all violent action and remain still. Once stopped one can then slowly withdraw each spike 9, 10, and it is this action that creates the hindrance to free movement.

As mentioned above, the barbed tape 1 may conveniently be formed by being punched out of a strip of material, such as stainless steel. The Applicant has discovered that an advantageous consequence of the punching process is that the tips of the spikes 9, 10 are sharpened as the material bends, whereas the rest of the barb 5, i.e. the arms 7, 8 and connecting portion 6 has a substantially square cut profile and is not therefore sharp. This is useful because it means that, whilst the barbs 5 remain effective at, for example, snagging clothing, they do not have sharpened, bladed edges (as is the case with conventional ‘razor wire’) and so the chance of causing severe injury to a person encountering the barbed tape 1 is reduced. Furthermore, with a barbed tape 1 of the above described configuration it is possible to adjust the severity of the effect provided by the tape 1 (in accordance with the intended use) by selecting the appropriate geometry and scale of the barbs 5 when the tape 1 is formed. For example, the more acute the angle at the tip of each spike 9, 10, the greater the ability of the spike to penetrate the clothing of a person coming into contact with the tape.

When the barbed tape 1 is made of natural stainless steel it has a high reflection index. Accordingly, the barbed tape 1 may be treated such that it exhibits a lower reflectivity (e.g. painted matt black), making it harder to see, or could be painted in bright colours or otherwise made clearly visible. Moreover, the barbed tape 1 may optionally contain markers which can readily be picked up specialised apparatus, such as night vision goggles or special eyewear or using dedicated (IR/UV) illumination torches.

FIGS. 3A and 3B show an embodiment in which a unit 300 comprises lengths of barbed tape 302 which are generally stowed in a frame 306 below a window 304. In this example, the tape 302 is stretched substantially vertically in the frame 306, although it may horizontal, diagonal or arranged in a variety of orientations.

The frame 306 is moveable such that it can be moved from a retracted, stowed, position shown in FIG. 3A (in this example, below a window) to a deployed position, in which it overlies the access point, as shown in FIG. 3B.

In this example, the unit 300 is arranged in the cavity of a cavity wall 308 and the frame 306 is introduced to the window 304 between the panes of a double glazing unit. This has the advantage that the barbed tape 302 is always covered, either by the wall 308 or by the panes of glass, unless the glass is broken while the frame is in the deployed position. In other examples, the unit 300 may comprise one or more side panels attached to the frame 306, which may be made of glass or the like (in particular, in some embodiments, translucent materials may be preferred), to enclose the barbed tape.

The arrangement is such that the unit can be placed across an access point to deter entry therethrough. In this example, the unit 300 also comprises pneumatic rams 310, and the frame 306 is simply raised by the rams 310 on activation of a security system, but in other examples the frame 306 could be lowered into position, raised from above or rotated about a hinge, or the like.

Alternative embodiments will occur to the skilled person and one such embodiment is illustrated in FIGS. 4A and 4B below. In this example, tape 402 is held coiled around a first rotatable bar 404, which therefore acts as a spool. The ends of the tape 402 are attached to a separate moveable bar 406, itself attached by pulleys 408 to a second rotatable bar 410, situated on the other side of an access point 412. This second rotatable bar 410 is associated with a motor 416, which turns the second bar 410, resulting in the pulleys 408 being drawn up along with the moveable bar 406. The tape 402 is thus unwound from the first rotatable bar 404 and such that it is stretched across the access point to assume the deployed position shown in FIG. 4B. The tape 402, first rotatable bar 404, moveable bar 406, pulleys 408 and second rotatable bar 410 therefore constitute a second embodiment of an access point security unit.

Again, in this example, the access point 412 is a double glazed window and the tape 402 is drawn up between the panes, but this need not be the case. One or more panes or similar materials could also be attached to the moveable bar 406, or moved by the pulleys 408, to cover the access point 412. Indeed such panes may be absent altogether.

Of course, variations will be apparent to the skilled person. For example, the unit could comprise separate rotatably mounted coils of barbed tape, each with its own spool, and each of these could be associated with its own pulley or other deployment apparatus. The tape 402 could be mounted above the window, or the sides, or to more than one side of the access point 412.

FIGS. 5A and 5B show a further alternative in a different context, specifically arranged to secure a cabinet, such as a jewellery cabinet 500. In this example, tape 502 is held coiled around a first rotatable bar 504, which therefore acts as a spool, in the base of the cabinet 500.

The cabinet 500 in this example has a glass top and two glass (and two solid) sides, and these glass sides and top constitute an access point. The ends of the tape 502 are attached to a separate moveable bar 506, itself attached by pulleys 508 to a second rotatable bar 510, situated on the other side of the cabinet 500. To the sides of the lengths of tape there is provided barb-free guide tapes 512, which are also wound about the first rotatable bar 504 and attached to the separate moveable bar 506. The pulleys 508 and, when unwound, the guide tapes 512 run in tracks within the solid side portion of the cabinet.

The second rotatable bar 504 is associated with a spring 516, which, when released, acts to turns the second bar 510, resulting in the pulleys 508 being drawn up along with the moveable bar 506. The tape 502 is thus unwound from the first rotatable bar and such that it is stretched up the first side of the cabinet 500, along the top and down the second glass side of the cabinet to assume the deployed position shown in FIG. 5B. The guide tapes 512 are held in the tracks and prevent the tape 502 from falling into the interior of the cabinet 500. The tape 502, first rotatable bar 504, moveable bar 506, pulleys 508 and second rotatable bar 510 therefore constitute a third embodiment of an access point security unit.

In this example, the ‘access point’ is the single glazed glass panels which constitute the cabinet cover and the tape 502 is drawn into a position which would be behind the glass, or exposed if the glass is broken. In the event that the glass was broken, an individual would be hindered from reaching into the cabinet 500 and withdrawing goods. One or more panes or similar materials could also be attached to the moveable bar 506, or moved by the pulleys 508, to cover the access point, which could otherwise be open. Indeed such panes may be absent altogether.

It will be noted that, in this embodiment, operation is much like a roll top writing bureau where the cover hides away in the interior of the desk when the desk is in use. In a preferred embodiment, the spring 516 is locked until a risk is detected. A risk may be detected automatically, for example if the cabinet 500 is tilted, or the glass broken, releasing the lock on the spring 512 and causing the second rotatable bar 504 to turn, or electrically, for example in response to the cabinet 500 being touched (which may cause a change in capacitance if the cabinet 500 is conductive or the like), or on activation of an alarm system or the like. However, the lock could also be activated manually, for example to provide additional security when a shop or gallery containing such a cabinet 500 is closed.

In similar examples, barbed tape could be located in such a position that, when stowed, it was not located between the sheets of glass:—e.g. in a shop front window display, which includes a platform or the like. The tape could be wound on bobbins located under the platform on which goods are displayed. In this position the tape is secure and invisible to the public side of the window display but could be viewed and accessed by shop staff from within the shop, for example on locking up or on activation of an alarm.

Of course, variations will be apparent to the skilled person, such as those variations outlined above. In particular, features and options discussed in relation to one embodiment could be combined with other embodiments.

As a matter of practise, it may be desired (or required by law) to clearly indicate the presence of possible injurious material. This could be achieved with a prominent warning notice, which may be integral to the access point, or may be integral to the unit, for example moved into position when the unit is placed in the deployed position.

In the embodiments described herein, the tape need not be ‘micro’ barbed tape. However, the advantage of micro-barbed tape is that it is unlikely to cause serious injury and is therefore appropriate for use in situations where it is important to keep injury to a minimum. Further, such tapes are small and relatively light, and, in particular in embodiments where the tape is stored in a coiled configuration, a relatively long length of tape can be stored in a relatively small space.

1. An access point security unit arranged, when deployed, to provide a hindrance to passage through an access point, the unit comprising a deployment apparatus and a plurality of lengths of barbed strip material, wherein the deployment apparatus is arranged to move the plurality of lengths of barbed strip material between a stowed position, in which the access point is not obstructed by barbed strip material, and a deployed position in which the plurality of lengths of barbed strip material lie across the access point.

2. An access point security unit according to claim 1 in which the barbed strip material is fully enclosed on all sides unless the access point is breached.

3. An access point security unit according to claim 1 in which, in the deployed position, the lengths of barbed strip material are interposed between sheets of translucent material.

4. An access point security unit according to claim 3 in which the lengths of barbed strip material are held in a frame, and the frame is moveable from the stowed position to the deployed position.

5. An access point security unit according to claim 4 in which the frame, is moveable from the stowed position to the deployed position, which deployed position is between the panes of a double glazing arrangement.

6. An access point security unit according to claim 4 in which the frame comprises one or more panes of glass arranged to substantially cover the access point.

7. An access point security unit according to claim 1 in which, in the stowed position, the barbed strip material is stored in a cavity formed within a wall in which the access point is formed.

8. An access point security unit according to claim 1 in which in at least one of the stowed/deployed positions, the barbed strips may be arranged substantially vertically, substantially horizontally, or in a mixture or orientations.

9. An access point security unit according to claim 1 in which the strip material is coiled on one or more spools when in the stowed position, and deployed by drawing the strip material from the spool(s).

10. An access point security unit according claim 1 which further comprises a motor associated with an energy source or other apparatus arranged to drive the deployment apparatus.

11. An access point security unit according to claim 1 in which the barbed strip material is comprises micro barbed tape.

12. An access point security unit according to claim 11 in which the micro barbed tape is produced from a stock tape of approximately 5-20 mm in width, between approximately 100-1000 microns in thickness and comprises barbs which are between appoximately 2 mm to 30 mm.
